(19) United States
(12) Patent Application Publication
(10) Pub. No.: US 2008/0235578 A1
(43) Pub. Date: Sep. 25, 2008

(54) INLINE EDITING OF WEB PAGE INPUT FIELDS USING A VISIBLY PROMINENT FIELD

(75) Inventors: Oscar Karl Magnus Heed, Malmo (SE); Nils Frans Pontus Jarenskog, Malmo (SE)

Correspondence Address: HARRITY SNYDER, L.L.P., 11350 RANDOM HILLS ROAD, SUITE 600, FAIRFAX, VA, 22030, US

(73) Assignee: SONY ERICSSON MOBILE COMMUNICATIONS AB, Lund (SE)

(21) Appl. No.: 11/690,519

(22) Filed: Mar. 23, 2007

(51) Int. Cl. G06F 3/048; G06F 15/00; G06F 17/24

(52) U.S. Cl. 715/269; 715/780

(57) ABSTRACT

A device, such as a mobile terminal, may display a web page to a user that includes an input field. The device may display, in response to selection of the input field by the user, a graphical overlay of the input field in which the graphical overlay covers at least a portion of the input field and text entered in the graphical overlay is more visibly prominent than text entered in the input field. A user of the device may enter text for the input field via the graphical overlay.

### BACKGROUND

Mobile communication devices, such as cellular telephones, have become increasingly versatile. For example, mobile telephones often support features in addition to voice communication. Such features may be implemented as software applications or programs on the communication device that enable the user to, for example, play music and games, obtain directions or maps to a place of interest, obtain sports scores, obtain weather information, or access email. Such additional features have made mobile telephones increasingly important to users.

One such additional feature that is commonly supported by mobile phones is the ability to connect to a data network, such as the Internet. For instance, a mobile phone may include a web browser designed to allow the user to surf the web using the mobile phone. An impediment to effectively viewing web content on a mobile phone is the fact that mobile phones typically have relatively small displays.

Small displays can be particularly frustrating to web surfers when filling out or editing of web pages that include forms. A web page that includes a form may be generally described as a web page that includes an input field in which the user enters text. Because of the small display sizes of typical mobile phones, the physical size of the input field can be small making the entered text difficult or unpleasant to read. One existing technique for improving the user experience when editing forms is to display a separate screen to the user when the user attempts to edit an input field. The separate screen may be one that is exclusively dedicated to entering text information that is to go into the input field. When the user finishes entering the text information, the display may revert back to displaying the web page. While this technique can help manage the small font size or small input field area associated with inline editing of data in the input field, the user loses focus from the web page on which the input field was originally placed, thus presenting a less than optimal browsing experience.

### SUMMARY

One aspect is directed to a method that includes displaying a web page to a user, the web page including an input field. The method further includes displaying, in response to selection of the input field by the user, a graphical overlay of the input field in which the graphical overlay covers at least a portion of the input field and text entered in the graphical overlay is more visibly prominent than text entered in the input field. The method further includes receiving input text for the input field via the graphical overlay.

Additionally, the method may include receiving a command to submit data entered for the web page to a web site and submitting the received input text to the web site.

Additionally, the method may include dynamically modifying a font of the text shown in the graphical overlay.

Additionally, the font size of the text shown in the graphical overlay may be made smaller as additional text is entered in the graphical overlay.

Additionally, the method may include resuming display of the web page, including the input field and without the graphical overly, when the user finishes entering the text in the graphical overlay.

Additionally, the method may include associating the text entered in the graphical overlay with the input field.

Additionally, the graphical overlay may cover all of the input field.

Additionally, the graphical overlay may be displayed by a web browser.

Additionally, the graphical overlay may be initially animated to graphically emerge from the input field.

Another aspect is directed to a mobile terminal that includes a display; a memory to store a plurality of instructions; and a processor to execute instructions in the memory. The instructions, when executed by the processor, may: provide a web page to a user of the mobile terminal via the display, the web page including a first input field, provide a second input field over at least a portion of the first input field in response to selection of the first input field by the user, and receive input text for the first input field via the second input field.

Additionally, the second input field may cover a larger area of the display than the first input field.

Additionally, the font of text in the second input field may be larger than the font of text in the first input field.

Additionally, the instructions may include instructions implemented in a web browser.

Additionally, the processor may execute the instructions in the memory to dynamically modify a font of the text shown in the second input field.

Additionally, the processor may execute the instructions in the memory to dynamically modify a font of the text shown in the second input field by reducing a size of the font as text is entered by the user.

Additionally, the second input field may completely cover the first input field.

Additionally, the processor may execute the instructions in the memory to remove the second input field from the web page when the user finishes inputting the text via the second input field.

Yet another aspect is directed to a device comprising means for displaying a web page to a user, the web page including an input field; means for displaying, in response to selection of the input field by the user, a graphical overlay of the input field in which the graphical overlay covers at least a portion of the input field and text entered in the graphical overlay is more visibly prominent than text entered in the input field; and means for receiving input text for the input field via the graphical overlay.

Additionally, the device may further include means for dynamically modifying a font of the text shown in the graphical overlay.

Additionally, the font of the text shown in the graphical overlay may be made smaller as additional text is entered in the graphical overlay.

### BRIEF DESCRIPTION OF THE DRAWINGS

The accompanying drawings, which are incorporated in and constitute a part of this specification, illustrate one or more implementations described herein and, together with the description, explain these implementations. In the drawings:

FIG. 1 is an exemplary diagram of a network in which systems and methods described herein may be implemented;

FIG. 2 is an exemplary front view of a mobile terminal;

FIG. 3 is a diagram of exemplary components of the mobile terminal shown in FIG. 2;

FIG. 4 is a flow chart illustrating exemplary operations that may be performed by a mobile terminal in presenting web page input fields to a user;

FIG. 5 is a diagram illustrating an exemplary web page that may be displayed on the display of a mobile terminal;

FIG. 6 is a diagram illustrating an exemplary web page after selection of an input field in the web page; and

FIGS. 7A-7C are additional diagrams illustrating an exemplary web page at various points after selection of an input field in the web page.

### DETAILED DESCRIPTION

The following detailed description refers to the accompanying drawings. The same reference numbers in different drawings may identify the same or similar elements. Also, the following detailed description does not limit the invention.

### Overview

Implementations described herein may provide for inline entering of text in an input field, such as a form on a web page, in which the input field is shown as a visibly prominent graphical overlay on the original input field. Advantageously, the user may be able to easily see which field is being edited and may be able to easily see the edits that are made. When the field is filled in, the field may return to its normal position in the web page.

### Exemplary Network Configuration

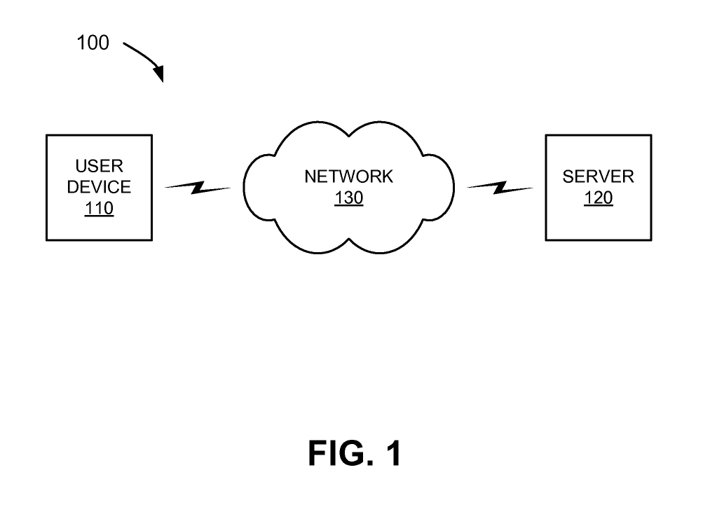

FIG. 1 is an exemplary diagram of a network 100 in which systems and methods described herein may be implemented. Network 100 may include a user device 110 and a server 120, which may communicate via network 130. One user device 110 and one server 120 have been illustrated as connected to network 130 for simplicity. In practice, there may be more user devices and/or servers. Also, in some instances, a user device may perform one or more functions of a server and a server may perform one or more functions of a user device.

User device 110 may be a portable device such as a wireless mobile terminal, such as a cellular phone, a personal digital assistant (PDA), a laptop, or another type of computation or communication device, a thread or process running on one of these devices, and/or an object executable by one of these devices. User device 110 may be a device that provides connectivity to network 130. For example, user device 110 may include browser software that allows the user to interact with resources over the network.

Server 120 may include one or more server entities that gather, process, search, and/or provide information to the user. For example, in one implementation, server 120 may include a web server that, upon request, provides web pages and/or information to user device 110.

Network 130 may include a local area network (LAN), a wide area network (WAN), a metropolitan area network (MAN), a telephone network, such as the Public Switched Telephone Network (PSTN) or a cellular telephone network, an intranet, the Internet, or a combination of networks. User device 110 and server 120 may connect to network 130 via wired, wireless, and/or optical connections. Although shown as a single network 130, network 130 may represent a number of different types of network. For example, when user device 110 is a cellular phone with web browsing capabilities, network 130 may represent a traditional cellular network through which a user may place wireless calls and a data network, such as the Internet, over which the user may browse various web pages.

### Exemplary User Device Configuration

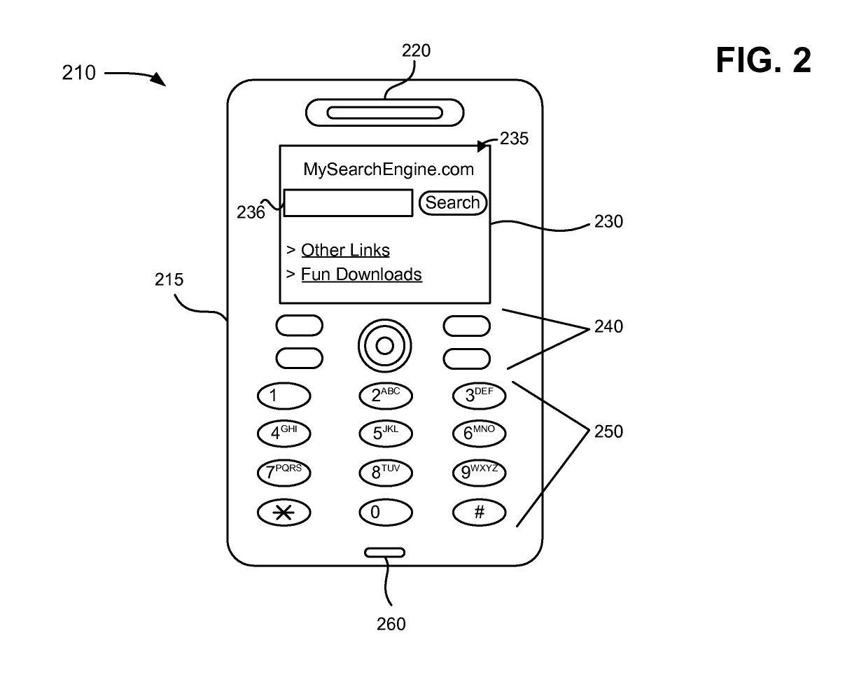

FIG. 2 is a front view of an exemplary implementation of user device 110, shown as mobile terminal 210. As shown in FIG. 2, mobile terminal 210 may include a housing 215, a speaker 220, a display 230, control buttons 240, a keypad 250, and/or a microphone 260. Housing 215 may protect the components of mobile terminal 210 from outside elements. Speaker 220 may provide audible information to a user of mobile terminal 210.

Display 230 may provide visual information to the user. For example, display 230 may display text input into mobile terminal 210, text and/or graphics received from another device, such as server 120, and/or information regarding incoming or outgoing calls, media, games, phone books, address books, the current time, etc. In one implementation, as shown in FIG. 2, display 230 may be used as an interface for a web browser executed by mobile terminal 210. An exemplary web page 235 is shown on display 230. Web page 235 includes an input field 236 in which a user may enter text, such as, in this example, a search query.

Control buttons 240 may permit the user to interact with mobile terminal 210 to cause mobile terminal 210 to perform one or more operations. For example, control buttons 240 may be used to cause mobile terminal 210 to transmit information. Microphone 260 may receive audible information from the user. Keypad 250 may include a standard telephone keypad and may be used to enter text into an input field such as input field 236. In some implementations, mobile terminal 210 may include a keypad 250 that includes a more standard computer keyboard, such as a QWERTY keyboard, or mobile terminal 210 may include an interface for connecting to a standard keyboard.

Although FIG. 2 shows exemplary components of mobile terminal 210, in other implementations, mobile terminal 210 may contain fewer, different, or additional components than depicted in FIG. 2. In still other implementations, one or more components of mobile terminal 210 may perform the tasks performed by one or more other components of mobile terminal 210.

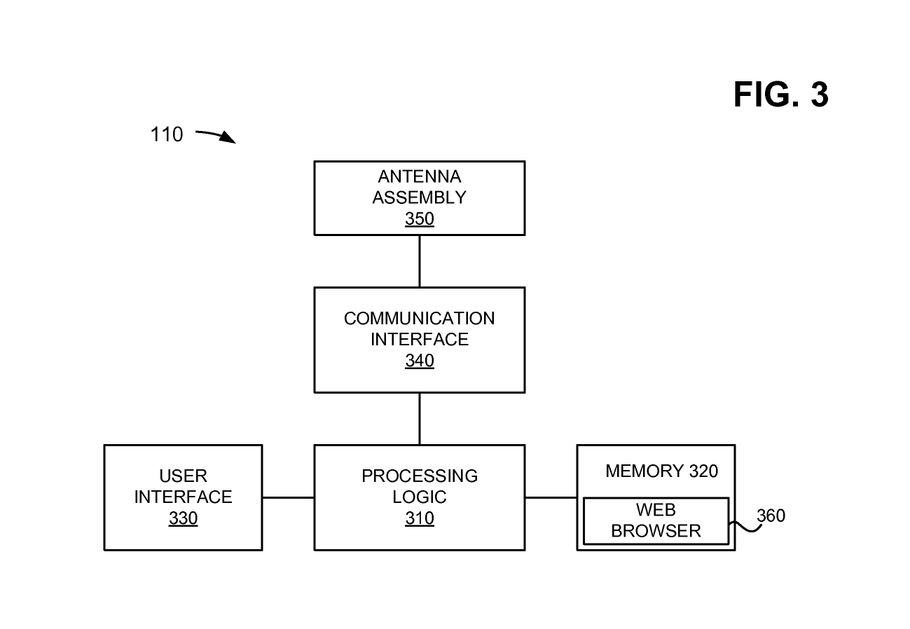

FIG. 3 is a diagram of exemplary components of mobile terminal 210. As shown in FIG. 3, mobile terminal 210 may include processing logic 310, memory 320, a user interface 330, a communication interface 340, and/or an antenna assembly 350. Processing logic 310 may include a processor, microprocessor, an application specific integrated circuit (ASIC), field programmable gate array (FPGA), or the like. Processing logic 310 may control operation of mobile terminal 210 and its components. Memory 320 may include a random access memory (RAM), a read only memory (ROM), and/or another type of memory to store data and instructions that may be used by processing logic 310.

User interface 330 may include mechanisms for inputting information to mobile terminal 210 and/or for outputting information from mobile terminal 210. Examples of input and output mechanisms may include buttons (e.g., control buttons 240, keys of keypad 250, a joystick, etc.) to permit data and control commands to be input into user device 110; a speaker (e.g., speaker 220) to receive electrical signals and output audio signals; a microphone (e.g., microphone 260) to receive audio signals and output electrical signals; a display (e.g., display 230) to output visual information (e.g., text input into to mobile terminal 210); and/or a vibrator to cause to mobile terminal 210 to vibrate.

Communication interface 340 may include, for example, a transmitter that may convert baseband signals from processing logic 310 to radio frequency (RF) signals and/or a receiver that may convert RF signals to baseband signals. Alternatively, communication interface 340 may include a transceiver to perform functions of both a transmitter and a receiver. Communication interface 340 may connect to antenna assembly 350 for transmission and/or reception of the RF signals. Antenna assembly 350 may include one or more antennas to transmit and/or receive RF signals over the air. Antenna assembly 350 may, for example, receive RF signals from communication interface 340 and transmit them over the air and receive RF signals over the air and provide them to communication interface 340. In one implementation, for example, communication interface 340 may communicate with a network, such as network 130.

As will be described in detail below, mobile terminal 210 may perform certain operations in response to processing logic 310 executing software instructions of an application contained in a computer-readable medium, such as memory 320. A computer-readable medium may be defined as a physical or logical memory device and/or carrier wave. The software instructions may be read into memory 320 from another computer-readable medium or from another device via communication interface 340. The software instructions contained in memory 320 may cause processing logic 310 to perform processes that will be described later. Alternatively, hardwired circuitry may be used in place of or in combination with software instructions to implement processes described herein. Thus, implementations described herein are not limited to any specific combination of hardware circuitry and software.

In one implementation, memory 320 may include instructions for implementing a web browser 360. Web browser 360 may be a web browser specifically designed for a mobile terminal or, in some implementations, a general purpose web browser. As described in more detail below, web browser 360 may modify the normal behavior of input fields so that the input fields are graphically animated and/or visibly more prominent than the normal or default behavior of the input field.

Although FIG. 3 shows exemplary components of mobile terminal 210, in other implementations, mobile terminal 210 may contain fewer, different, or additional components than depicted in FIG. 3. In still other implementations, one or more components of mobile terminal 210 may perform the tasks performed by one or more other components of mobile terminal 210.

### Exemplary Operation of Mobile Terminal

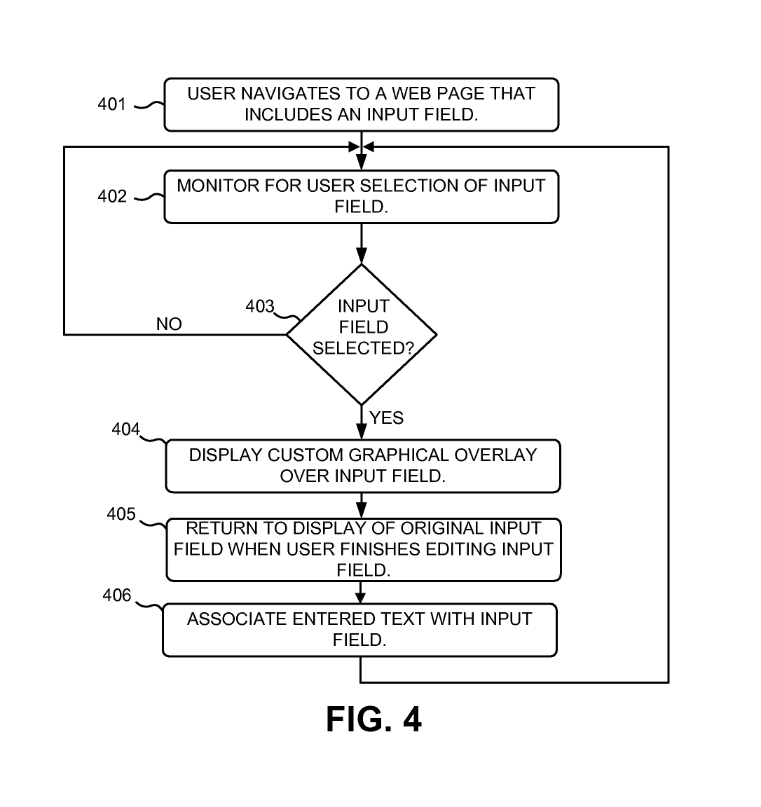

FIG. 4 is a flow chart illustrating exemplary operations that may be performed by mobile terminal 210 in presenting web page input fields to a user. In general, as will be described in more detail below, a “normal” input field may be replaced by a “custom,” more visibly prominent, input field. The custom input field provides for an improved user experience when editing (i.e., entering information) in the input field.

The operations of FIG. 4 may begin when a user navigates to a web page that includes an input field (act 401). The web page may be displayed as normal by mobile terminal 210.

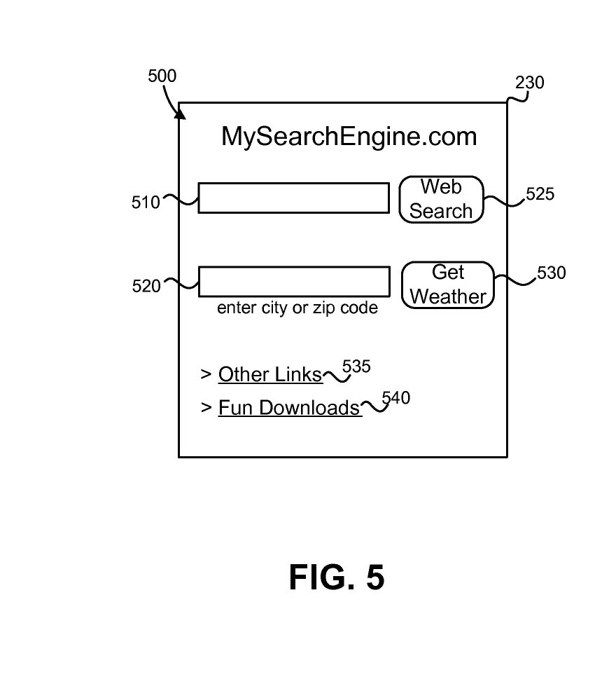

FIG. 5 is diagram illustrating an example of a web page 500 that may be displayed on display 230 of mobile terminal 210. Web page 500 may have been downloaded from server 120 and may be rendered by a web browser 360 on mobile terminal 210. Web page 500 includes two input fields, 510 and 520. As shown, input field 510 is a field in which a user may enter a general search query. Input field 520 is a weather information search field in which the user may enter address information, such as a zip code or city, to get the current weather forecast for that location. Web page 500 may include additional elements, such as buttons 525 and 530 through which the user may initiate a web search or weather lookup, respectively. Web page 500 is also shown as including links 535 and 540, respectively. Selecting either of links 535 or 540 may take the user to a different web page.

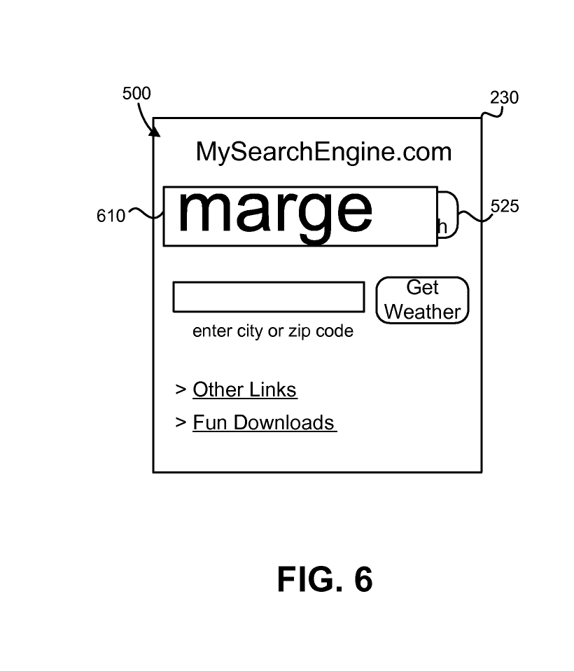

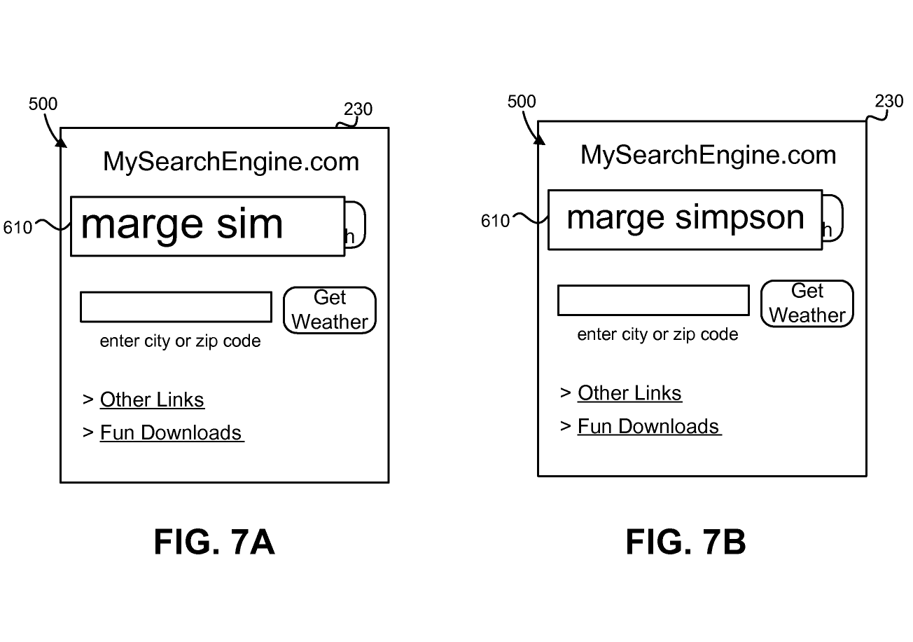

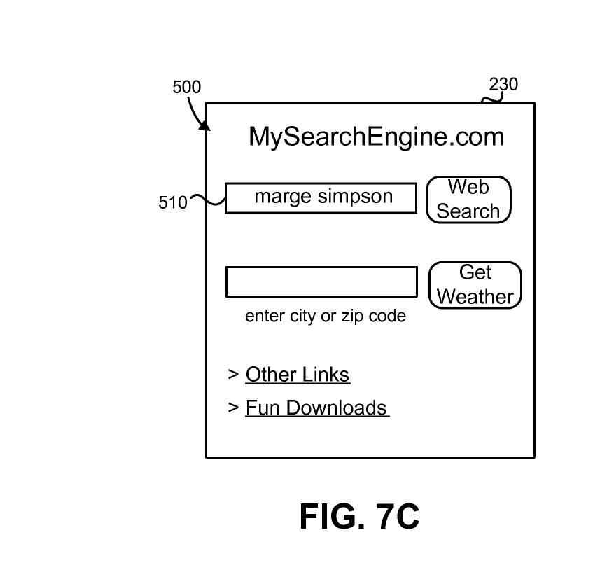

Mobile terminal 210 may monitor web page 500 to determine when the user selects an input field (e.g., input field 510 or 520) (act 402). The user may select an input field using, for example, control buttons 240 or keypad 250. At some point, the user may select an input field (act 403—YES). In response, mobile terminal 210 may display a custom graphic overlay that acts as an alternate input field to the user (act 404). The custom input field may be a visibly prominent graphical overlay and will now be described in more detail with reference to FIGS. 6 and 7.

Assume that the user selects input field 510 in web page 500. FIG. 6 is diagram illustrating web page 500 after selection of input field 510. As shown, mobile terminal 210 may, instead of presenting input field 510 in its “normal” view (i.e., as shown in FIG. 5), present the input field as a custom input field 610 (FIG. 6). Input field 610 may be a graphical field that “pops out” or graphically emerges from input field 510. Input field 610 may thus be a graphical overlay of input field 510, in which input field 610 is more visibly prominent than input field 510. Input field 610, although larger than input field 510, may still be shown inline within web page 500. In other words, input field 610 may remain near the original position of the input field in web page 500, and the user can continue to view most or all of the remainder of web page 500. Input field 610 may overlay input field 510 and other portions of web page 500, such as, in the example of FIG. 6, button 525.

As is further shown in FIG. 6, assume the user has entered the text “marge” in input field 610. The text may be of a larger font than would normally be entered into a standard input field, such as input field 510. In this manner, the text entered into input field 610 is more prominent and may provide a better viewing experience for the user. This may help ensure that the user has correctly entered the desired information.

Consistent with an aspect of the invention, mobile terminal 210 may dynamically alter the size of the text (e.g., the font size) as the user continues to enter additional text. The size of the text may be altered to optimize the position of the text within input field 610. FIGS. 7A and 7B are diagrams illustrating the dynamic changing of font size as the user enters additional text into an input field. Assume that the user continues to enter text into input field 610. As shown in FIG. 7A, the user has entered the text “marge sim” into field 610. Mobile terminal 210 may reduce the font size in order to keep the entered text to a size that fits into field 610 and/or on display 230. The font size may be reduced while the user enters the text. As shown in FIG. 7B, the user has now entered the text “marge simpson” and the font size is again reduced so that the entered text fits into input field 610 to allow all the entered text to be viewed without scrolling through input field 610. In some implementations, once the word “marge” has been entered, mobile terminal 210 may reduce the size of this word and continue to allow the user to enter the next word via a larger font.

Referring back to FIG. 4, at some point, the user may finish providing information to input field 610. The user may indicate that he/she has finished providing information/editing input field 610 by, for example, pressing an “enter” key or selecting another element on web page 500. In response, mobile terminal 210 may change input field 610 back to the original input field 510 (FIG. 4, act 405). The original input field, input field 510, may include the text entered into input field 610 by the user. The entered text may be associated with input field 510 (act 406) and, at this point, may be considered to be functionally identical to text entered if the user had entered the text in the normal manner (i.e., in original input field 510).

FIG. 7C is a diagram illustrating web page 500 after the user has finished editing input field 610. As shown, input field 510 is displayed as the original input field that was rendered by web browser 360 pursuant to, for example, the hyper-text markup language (HTML) that defined web page 500. The entered text “marge Simpson” is shown in its normal size (i.e., the size dictated by browser 360 and web page 500 in the course of normal rendering of web page 500).

It can be appreciated that the particular visual style of custom input field 610 is not critical and that other visual styles, fonts, or other elements may be changed. For example, the custom input field may a distinctive color, include a distinctive border, be of a shape other than rectangular, etc. Also, as mentioned, when custom input 610 field is initially displayed (act 404), it may, in some implementations, graphically grow or “pop out” of the original input field. In still other implementations, one or more buttons associated with custom input field 610, such as button 525, may be expanded or moved to allow the user to easily enter or transmit the information using customized (e.g., larger) buttons.

### Conclusion

Implementations described above may allow for an improved user experience when navigating documents such as web pages on devices with limited screen sizes. The custom input field described above may be a larger than normal input field which may “pop out” or “grow” from the original field, thus providing a more visually distinctive and more easily useable input field. When the user has finished editing the custom input field, the custom input field may be replaced with a filled-in version of the original input field.

The foregoing description of implementations provides illustration and description, but is not intended to be exhaustive or to limit the invention to the precise form disclosed. Modifications and variations are possible in light of the above teachings or may be acquired from practice of the invention. For example, while the implementations described herein were primarily described in reference to a web browser executing on a mobile terminal, it can be appreciated that the concepts described could be implemented on other platforms with limited display area, such as PDAs, music playing devices, or by software other than a traditional browser.

For example, while a series of acts has been described with regard to FIG. 4, the order of the acts may be modified in other implementations. Further, non-dependent acts may be performed in parallel.

Also, the term “user” has been used herein. The term “user” is intended to be broadly interpreted to include a user device or a user of a user device.

It should be emphasized that the term “comprises/comprising” when used in this specification is taken to specify the presence of stated features, integers, steps, or components, but does not preclude the presence or addition of one or more other features, integers, steps, components, or groups thereof.

It will be apparent that aspects, as described above, may be implemented in many different forms of software, firmware, and hardware in the implementations illustrated in the figures. The actual software code or specialized control hardware used to implement these aspects should not be construed as limiting. Thus, the operation and behavior of the aspects were described without reference to the specific software code—it being understood that software and control hardware could be designed to implement the aspects based on the description herein.

No element, act, or instruction used in the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A method, comprising:
displaying a web page to a user, the web page including an input field;
displaying, in response to selection of the input field by the user, a graphical overlay of the input field in which the graphical overlay covers at least a portion of the input field and text entered in the graphical overlay is more visibly prominent than text entered in the input field; and
receiving input text for the input field via the graphical overlay.

2. The method of claim 1, further comprising:
receiving a command to submit data entered for the web page to a web site; and
submitting the received input text to the web site.

3. The method of claim 1, further comprising:
dynamically modifying a font of the text shown in the graphical overlay.

4. The method of claim 3, wherein the font size of the text shown in the graphical overlay is made smaller as additional text is entered via the graphical overlay.

5. The method of claim 1, further comprising:
resuming display of the web page, including the input field and without the graphical overlay, when the user finishes entering the text via the graphical overlay.

6. The method of claim 5, further comprising:
associating the text entered via the graphical overlay with the input field.

7. The method of claim 1, wherein the graphical overlay covers all of the input field.

8. The method of claim 1, wherein the graphical overlay is displayed by a web browser.

9. The method of claim 1, wherein the graphical overlay is initially animated to graphically emerge from the input field.

10. A mobile terminal comprising:
a display;
a memory to store a plurality of instructions; and
a processor to execute instructions in the memory to:
provide a web page to a user of the mobile terminal via the display, the web page including a first input field,
provide a second input field over at least a portion of the first input field in response to selection of the first input field by the user, and
receive input text for the first input field via the second input field.

11. The mobile terminal of claim 11, wherein the second input field covers a larger area of the display than the first input field.

12. The mobile terminal of claim 11, wherein a font associated with text input via the second input field is larger than a font associated with text input via the first input field.

13. The mobile terminal of claim 10, wherein the instructions include instructions implemented in a web browser.

14. The mobile terminal of claim 10, wherein the processor executes the instructions in the memory to:
dynamically modify a font of the text input via the second input field.

15. The mobile terminal of claim 14, wherein the processor executes the instructions in the memory to:
dynamically modify a font of the text shown in the second input field by reducing a size of the font as text is entered by the user.

16. The mobile terminal of claim 10, wherein the second input field completely covers the first input field.

17. The mobile terminal of claim 10, wherein the processor executes the instructions in the memory to:
remove the second input field from the web page when the user finishes inputting the text via the second input field.

18. A device comprising:
means for displaying a web page to a user, the web page including an input field;
means for displaying, in response to selection of the input field by the user, a graphical overlay of the input field in which the graphical overlay covers at least a portion of the input field and text entered in the graphical overlay is more visibly prominent than text that would be entered in the input field; and
means for receiving input text for the input field via the graphical overlay.

19. The device of claim 18, further comprising:
means for dynamically modifying a font of the text entered via the graphical overlay.

20. The device of claim 18, wherein the font of the text entered via the graphical overlay is made smaller as additional text is entered via the graphical overlay.
